(19) United States
(12) Patent Application Publication
(10) Pub. No.: US 2024/0347035 A1
(43) Pub. Date: Oct. 17, 2024

(54) SIGNAL PROCESSING DEVICE, SIGNAL PROCESSING METHOD, PROGRAM, AND ACOUSTIC SYSTEM

(71) Applicant: Sony Group Corporation, Tokyo (JP)

(72) Inventors: Tetsunori Itabashi, Kanagawa (JP); Shigetoshi Hayashi, Tokyo (JP)

(73) Assignee: Sony Group Corporation, Tokyo (JP)

(21) Appl. No.: 18/682,732

(22) PCT Filed: Mar. 17, 2022
(86) PCT No.: PCT/JP2022/012301

§ 371 Date: Feb. 9, 2024

(30) Foreign Application Priority Data
Aug. 19, 2021 (JP) 2021-134154

(51) Int. Cl. G10K 11/178; H04R 3/00

(52) U.S. Cl. CPC G10K 11/17854; G10K 11/17881; H04R 3/002

(57) ABSTRACT

Provided are a signal processing device, a signal processing method, a program, and an acoustic system capable of reducing noise in a state where a microphone is not installed at a position where noise is desired to be reduced.

Provided is a signal processing device including: an observation filter processing unit that generates, on the basis of an output signal from a first error microphone, an estimated output signal obtained using one or more of a plurality of observation filters to estimate an output signal from a second error microphone; and an adaptive filter that generates a noise reduction signal on the basis of an output signal from a reference microphone and the estimated output signal.

### TECHNICAL FIELD

The present technology relates to a signal processing device, a signal processing method, and a program.

### BACKGROUND ART

Conventionally, there is a so-called spatial noise cancellation method that uses a speaker and a microphone to reduce noise in a space. In spatial noise cancellation, an adaptive filter that accounts for movement of a noise source is often used (Patent Document 1).

### CITATION LIST

### Patent Document

Patent Document 1: ICASSP2019 CAUSALITY AND ROBUSTNESS IN THE REMOTE SENSING OF ACOUSTIC PRESSURE, WITH APPLICATION TO LOCAL ACTIVE SOUND CONTROL S. J. Elliott, W. Jung and J. Cheer

### SUMMARY OF THE INVENTION

### Problems to be Solved by the Invention

When the adaptive filter is used, it is necessary to install a reference microphone near a noise source and install an error microphone in a range where noise is reduced, but it is difficult to place the error microphone in a desired place. The fact that the position where the error microphone should be placed is within a range where noise is desired to be reduced means that it is necessary to install the error microphone in a place where people are present, but there is a problem with physical difficulties in installing the error microphone because the error microphone disturbs the motion and movement of people. Furthermore, another problem is that in a case where the error microphone is installed in a different position, the noise cancellation effect is reduced.

The present technology has been made in view of such problems, and an object of the present technology is to provide a signal processing device, a signal processing method, a program, and an acoustic system 10 capable of reducing noise in a state where a microphone is not installed at a position where noise is desired to be reduced.

### Solutions to Problems

To solve the problems described above, a first technology is a signal processing device including: an observation filter processing unit that generates, on the basis of an output signal from a first error microphone, an estimated output signal obtained using one or more of a plurality of observation filters to estimate an output signal from a second error microphone; and an adaptive filter that generates a noise reduction signal on the basis of an output signal from a reference microphone and the estimated output signal.

Furthermore, a second technology is a signal processing method including: generating, on the basis of an output signal from a first error microphone, an estimated output signal obtained using one or more of a plurality of observation filters to estimate an output signal from a second error microphone; and generating a noise reduction signal on the basis of an output signal from a reference microphone and the estimated output signal.

Furthermore, a third technology is a program for causing a computer to perform a signal processing method including generating, on the basis of an output signal from a first error microphone, an estimated output signal obtained using one or more of a plurality of observation filters to estimate an output signal from a second error microphone, and generating a noise reduction signal on the basis of an output signal from a reference microphone and the estimated output signal.

Moreover, a fourth technology is an acoustic system including: a first error microphone; a reference microphone; an observation filter processing unit that generates, on the basis of an output signal from the first error microphone, an estimated output signal obtained using one or more of a plurality of observation filters to estimate an output signal from a second error microphone; an adaptive filter that generates a noise reduction signal on the basis of an output signal from the reference microphone and the estimated output signal; and a speaker that outputs the noise reduction signal.

### BRIEF DESCRIPTION OF DRAWINGS

FIG. 1 is an explanatory diagram of a general adaptive filter system.

FIG. 2 is a configuration diagram of an adaptive filter system using a virtual microphone.

FIG. 3 is an explanatory diagram of creation of an observation filter by measurement.

FIG. 4 is an explanatory diagram of creation of an observation filter by artificial intelligence.

FIG. 5 is an explanatory diagram of installation of a virtual error microphone and a monitor error microphone.

FIG. 6 is an explanatory diagram of a position of a noise source and accuracy of noise cancellation.

FIG. 7 is an explanatory diagram of a position of a noise source and accuracy of noise cancellation.

FIG. 8 is an explanatory diagram of positions of noise sources and accuracy of noise cancellation.

FIG. 9 is a block diagram illustrating a configuration of an acoustic system 10.

FIG. 10 is a block diagram illustrating a configuration of a signal processing device 100 in a first embodiment.

FIG. 11 is a plan view for explaining virtual noise sources used in the signal processing device 100 at the time of creating an observation filter.

FIG. 12 is a flowchart illustrating the processing of the signal processing device 100 in the first embodiment.

FIG. 13 is an explanatory diagram of processing by a noise-source-direction estimation unit 110.

FIG. 14 is a block diagram illustrating a configuration of a signal processing device 100 according to a second embodiment.

FIG. 15 is a flowchart illustrating the processing of the signal processing device 100 in the second embodiment.

FIG. 16 is a diagram illustrating a first specific example of the implementation of the present technology.

FIG. 17 is a diagram illustrating a second specific example of the implementation of the present technology.

FIG. 18 is a diagram illustrating a second specific example of the implementation of the present technology.

FIG. 19 is a diagram illustrating a third specific example of the implementation of the present technology.

FIG. 20 is a diagram illustrating a modification of the arrangement of the virtual noise sources.

### MODE FOR CARRYING OUT THE INVENTION

Hereinafter, embodiments of the present technology will be described with reference to the drawings. Note that the description will be made in the following order.

<1. First Embodiment>

[1-1. Configuration of general adaptive filter system]

[1-2. Overview of virtual microphone technology]

[1-3. Configuration of acoustic system 10]

[1-4. Configuration of signal processing device 100]

[1-5. Processing by signal processing device 100]

<2. Second Embodiment>

[2-1. Configuration of signal processing device 100]

[2-2. Processing by signal processing device 100]

<3. Specific examples of implementation>

<4. Modifications>

### 1. First Embodiment

### [1-1. Configuration of General Adaptive Filter System]

An adaptive filter is often used to reduce noise in a space through spatial noise cancellation. In a typical space, the location of a noise source generating noise may not be known, the noise source may move, or the state of the space may change. Therefore, an adaptive filter system switches a filter coefficient for noise reduction while adapting to the movement of the noise source and changes in the state of the space.

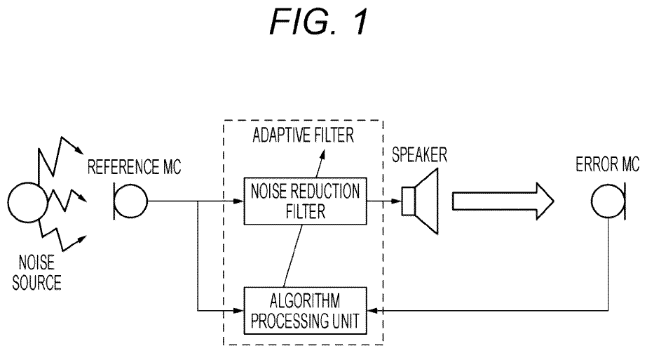

As illustrated in FIG. 1, the adaptive filter system includes: a reference microphone installed near a noise source; an error microphone installed in a space (hereinafter referred to as a target space) to be subjected to noise reduction processing to obtain an error in noise reduction; an adaptive filter that generates a noise reduction signal; and a speaker that outputs the noise reduction signal. Note that, in the drawings, the microphone may be referred to as MC.

The adaptive filter includes a noise reduction filter and an algorithm processing unit.

The adaptive filter generates a noise reduction signal by convolving a filter coefficient with sound collected by the reference microphone so that a signal input to the error microphone is reduced. Then, noise cancellation is performed by outputting the noise reduction signal from the speaker. At the time of generating the noise reduction signal, if an adaptive algorithm such as least mean square (LMS) is used in an algorithm processing unit, the filter converges so that the sound pressure at the position where the error microphone is installed automatically approaches zero.

The error microphone needs to be installed in a target space where noise is desired to be reduced, but in general, the space where noise is desired to be reduced is a space where people are present. Therefore, when the error microphone is installed in the target space where noise is desired to be reduced, the behavior and visibility of people are disturbed, which is problematic. Therefore, the present technology uses a technology called a virtual microphone in which an error microphone is installed at a position that does not disturb people.

### [1-2. Overview of Virtual Microphone Technology]

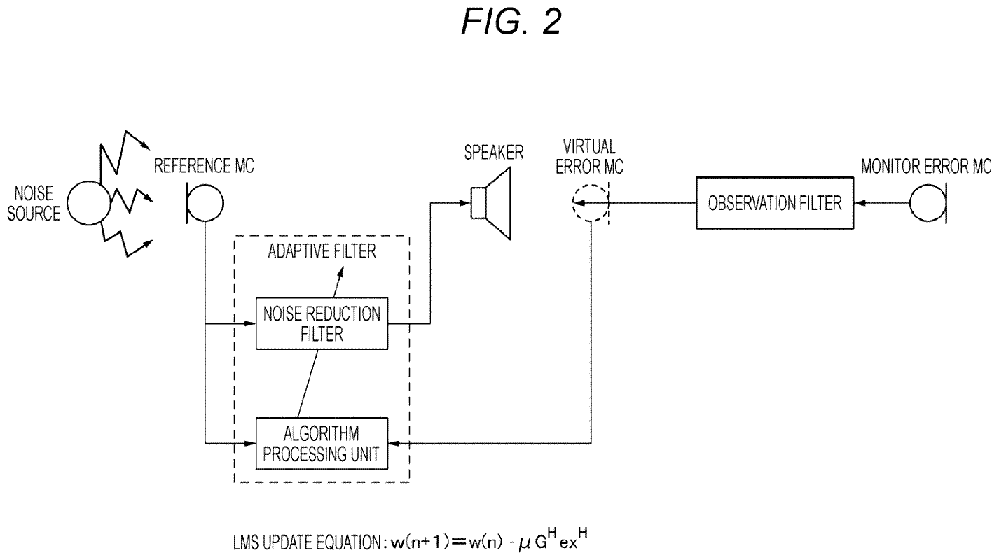

Next, an outline of the virtual microphone technology will be described. In the adaptive filter system using the virtual microphone illustrated in FIG. 2, two types of error microphones, a virtual error microphone and a monitor error microphone, are used. The virtual error microphone is installed in a target space where noise is desired to be reduced similarly to a normal error microphone before the performance of noise cancellation, and is removed at the time of performing noise cancellation. On the other hand, the monitor error microphone is installed at a position that does not disturb the behavior and visibility of people, and is continuously installed without being removed even at the time of performing noise cancellation. The reference microphone, the adaptive filter, and the speaker are similar to those illustrated in FIG. 1.

In addition, in the adaptive filter system using the virtual microphone, an observation filter is created before the performance of noise cancellation by using actual measurement data acquired by simulation or measurement using the virtual error microphone and a monitor error microphone installed in advance. The observation filter is a signal processing block that generates, from a signal of the monitor error microphone, an estimated output signal obtained by estimating an output signal of the virtual error microphone that is removed at the time of performing noise cancellation.

After the creation of the observation filter, the virtual error microphone is removed at the time of performing noise cancellation, and the monitor error microphone remains in the installed state. Then, by inputting the output signal of the monitor error microphone to the observation filter, an estimated output signal obtained by estimating the output signal of the virtual error microphone, which has been removed at the time of performing noise cancellation, is generated and input to the adaptive filter. This makes it possible to artificially input the output signal of the error microphone at the installation position of the virtual error microphone, which has been removed at the time of performing noise cancellation, to the adaptive filter to generate a noise reduction signal. By outputting the noise reduction signal from the speaker, it is possible to reduce noise in the target space including the position where the virtual error microphone is installed.

At the time of performing noise cancellation, the virtual error microphone has been removed, and what is present is the monitor error microphone installed at a position that does not disturb people. Accordingly, neither the virtual error microphone nor the monitor error microphone disturbs people.

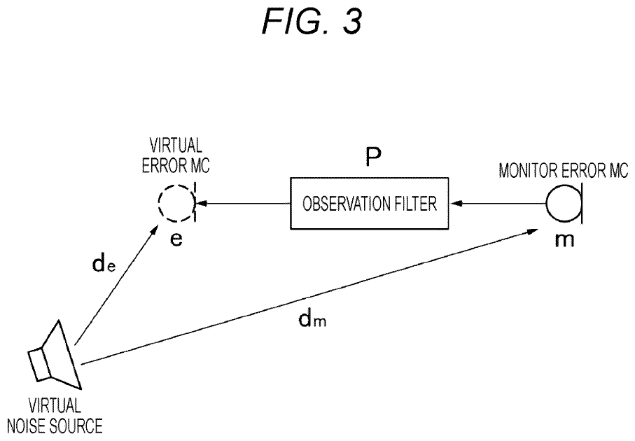

Here, a method of creating the observation filter will be described with reference to FIG. 3. When the output signal of the virtual error microphone is “e”, the output signal of the monitor error microphone is “m”, and the observation filter is “P”, the output signal e of the virtual error microphone can be expressed by the following Equation 1.

$$e = Pm \qquad [ Equation 1 ]$$

At the time of creating the observation filter by using actual measurement data acquired by measurement, the virtual error microphone and the monitor error microphone are installed, and moreover, a speaker is installed as a virtual noise source at a position where a noise source is assumed to be actually present.

Here, “de” is a transfer function from the virtual noise source to the virtual error microphone, and “dm” is a transfer function from the virtual noise source to the monitor error microphone.

Then, a measurement signal is output from the virtual noise source, and the transfer function de from the virtual noise source to the virtual error microphone and the transfer function dm from the virtual noise source to the monitor error microphone are obtained. The transfer function can be obtained by using a time stretched pulse (TSP) signal, pink noise, white noise, or the like as in normal sound field measurement.

Then, by using the transfer function de and the transfer function dm, an observation filter P can be created by the following Equation 2.

$$P = {( {dm}^{⋆} {dm}^{H} )}^{- 1 ⋆} ( {dm}^{⋆} {de}^{H} ) \qquad [ Equation 2 ]$$

Note that, although the virtual error microphone is actually installed to create the observation filter, the virtual error microphone can be removed in advance because the output signal of the virtual error microphone can be estimated by Equation 1 at the time of actual noise cancellation.

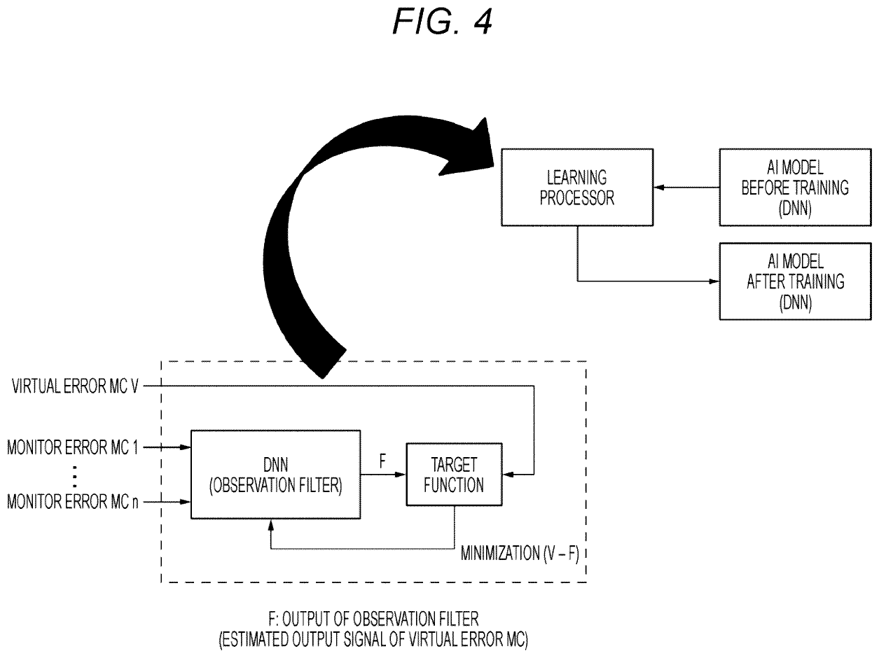

In addition, it is also possible to create the observation filter by using artificial intelligence. FIG. 4 is a diagram illustrating a training deep neural network (DNN) circuit for training a learned model of the observation filter that estimates the output signal of the virtual error microphone by using artificial intelligence. The artificial intelligence is trained during learning to estimate the output signal of the virtual error microphone from the output signal of the monitor error microphone.

As illustrated in FIG. 4, by using an output signal V from the virtual error microphone and output signals from a plurality of monitor error microphones (1 to n), an objective function is defined to minimize the difference (V-F) between the output signal V of the virtual error microphone and an output F of the observation filter (the estimated output signal of the virtual error microphone. It is thereby possible to create the observation filter by using artificial intelligence.

Note that a machine learning algorithm can be used as artificial intelligence, and a deep neural network can further be used as the machine learning algorithm. In addition, the trained deep neural network may also be referred to as a learned model.

Note that, when the learned model is used as the observation filter, the objective function is unnecessary, and the output F of the observation filter serves as the estimated output signal of the virtual error microphone.

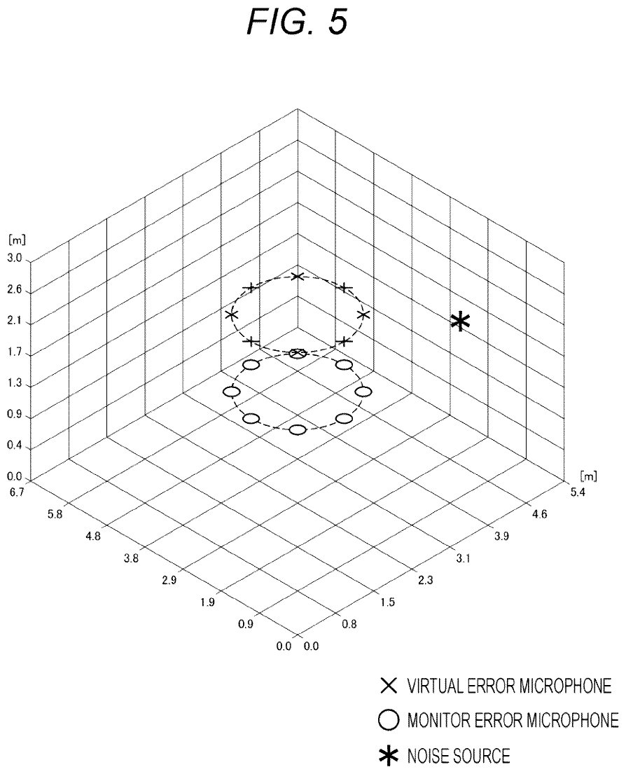

Next, the installation of the virtual error microphone and the monitor error microphone will be described with reference to FIG. 5. As illustrated in FIG. 5, when a plurality of virtual error microphones is installed in accordance with the height of the position of a person in a target space that is a target of noise cancellation, a noise cancellation effect can be more effectively obtained in a wide range. However, as described above, the virtual error microphone is removed at the time of performing noise cancellation performance because the actual presence of the microphone in this position disturbs the behavior and visibility of people active in the target space.

In contrast, the monitor error microphone is disposed at a position that does not disturb the behavior and visibility of people. For example, the plurality of monitor error microphones is disposed in the same annular shape as the virtual error microphone and are installed at positions immediately above the installation position of the virtual error microphone. Specifically, the plurality of monitor error microphones is installed by being attached to a ceiling of a room or the like constituting the target space or being suspended from the ceiling. The monitor error microphone may be installed by any method as long as the installation position does not disturb the behavior and visibility of people.

Note that the monitor error microphone is not necessarily provided immediately above the virtual error microphone. In addition, the plurality of monitor error microphones and the virtual error microphones do not necessarily need to be arranged in an annular shape, and may be arranged in accordance with the shape of the room including the target space or the like.

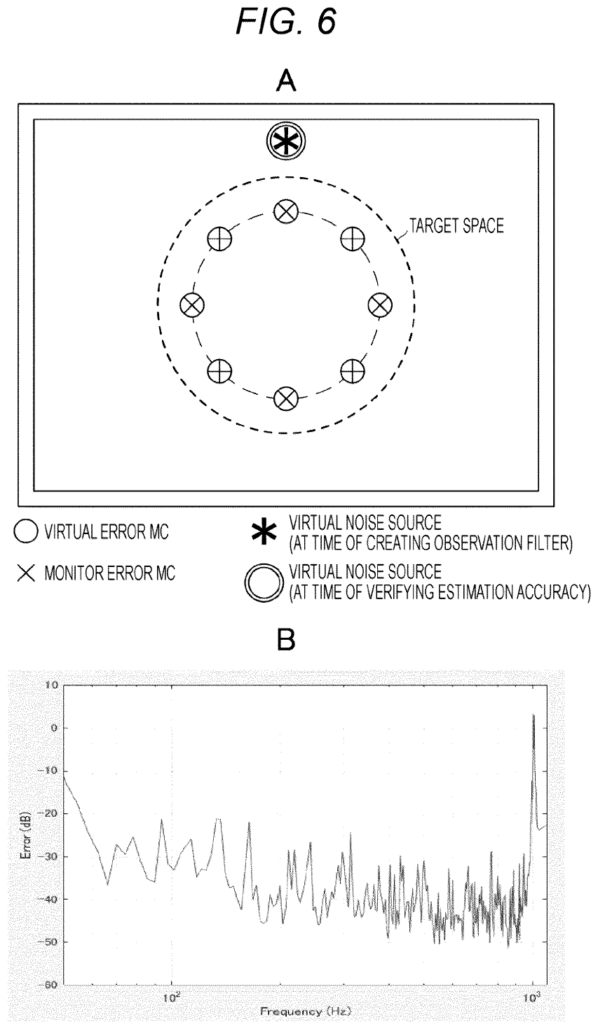

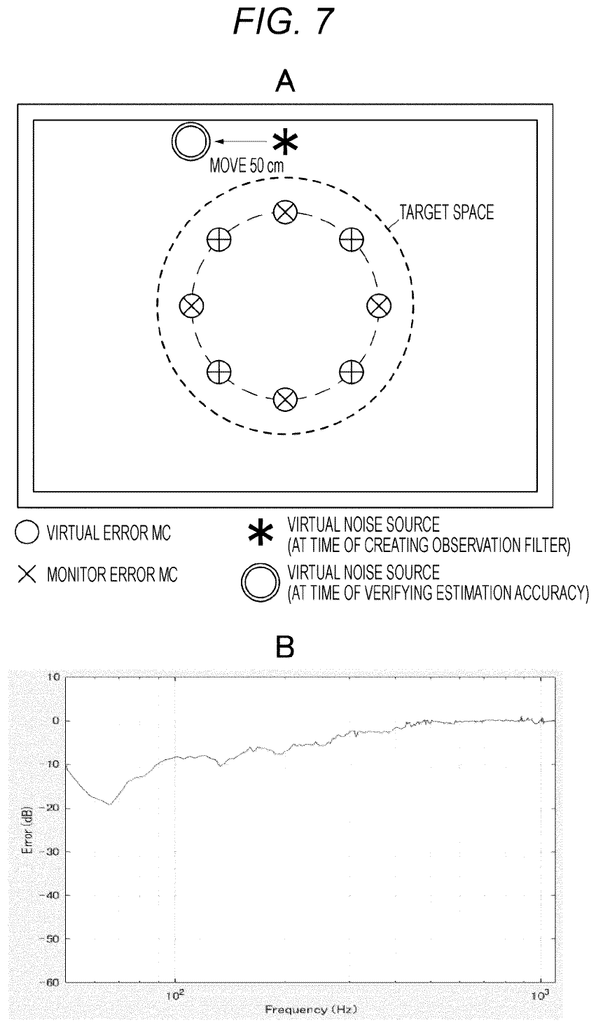

Next, the position of the virtual noise source and the accuracy of noise cancellation in the adaptive filter system using the virtual error microphone will be described with reference to FIGS. 6 and 7. FIG. 6A illustrates a case where the number of virtual noise sources is one, and the position of the virtual noise source at the time of creating the observation filter is the same as the position of the virtual noise source at the time of verifying the estimation accuracy of the estimated output signal of the virtual error microphone generated by the observation filter. In this case, as illustrated in FIG. 6B, the accuracy is high in the estimated output signal of the virtual error microphone generated using the output signal of the monitor error microphone.

On the other hand, FIG. 7A illustrates a case where there is one virtual noise source, and the position of the virtual noise source at the time of creating the observation filter is different from the position of the virtual noise source at the time of verifying the estimation accuracy of the estimated output signal of the virtual error microphone generated by the observation filter. In FIG. 7A, it is assumed that the virtual noise source has moved 50 cm. In this case, as illustrated in FIG. 7B, compared to the case illustrated in FIG. 6, the accuracy is low in the estimated output signal of the virtual error microphone generated using the output signal of the monitor error microphone. In particular, the accuracy is lowered in a high range.

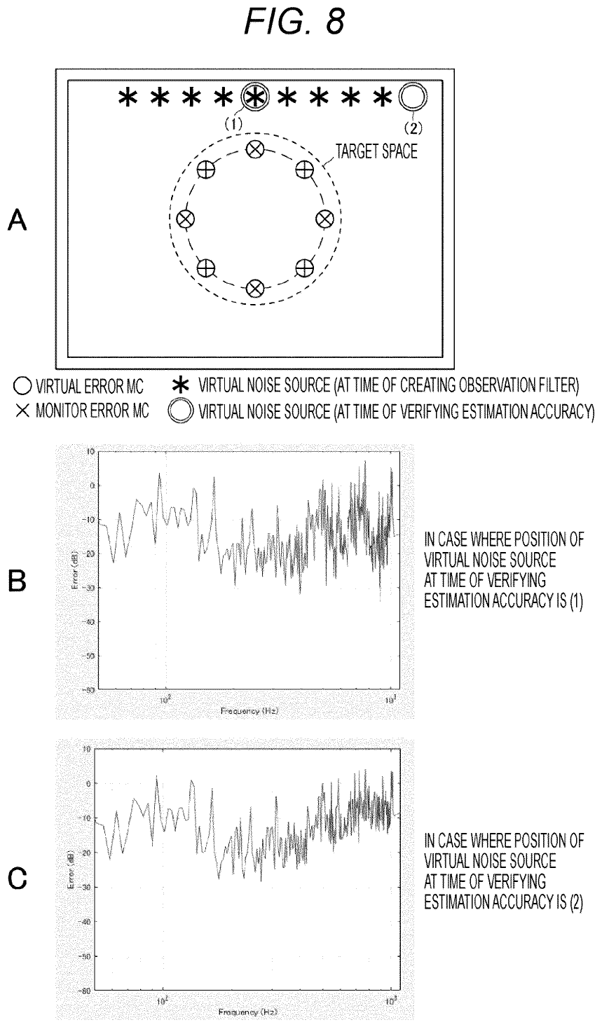

In contrast, FIG. 8A illustrates a case where there is a plurality of virtual noise sources, and the plurality of virtual noise sources is arranged substantially linearly to create the observation filter. In a case where the virtual noise source at the time of verifying the estimation accuracy of the estimated output signal of the virtual error microphone is located at a position (1) in FIG. 8A and in a case where the virtual noise source is located at a position (2) in FIG. 8A, the accuracy of the estimated output signal of the virtual error microphone is high as illustrated in FIGS. 8B and 8C. In addition, the accuracy in the high frequency range is only slightly worse at the position (1) and the position (2). This result has little effect on noise cancellation because the low frequency is generally more important in noise cancellation. It can thus be said that the noise cancellation effect is not impaired even by the movement of the noise source when the observation filter is created using the noise sources at a plurality of different positions rather than when the observation filter is created using one noise source.

However, there is a problem with lowered accuracy in noise reduction when one observation filter handles noises coming from all directions. Therefore, in the present technology, a plurality of observation filters corresponding to respective directions is created in advance.

### [1-3. Configuration of Acoustic System 10]

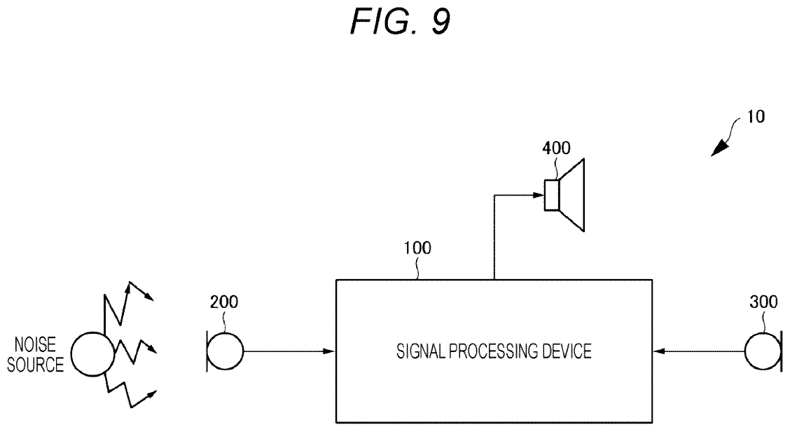

Next, a configuration of an acoustic system 10 including a signal processing device 100 according to the present technology will be described with reference to FIG. 9. The acoustic system 10 includes the signal processing device 100, a reference microphone 200, a monitor error microphone 300, and a speaker 400.

The reference microphone 200 is a microphone for collecting noise from a noise source that is a target of noise cancellation.

The monitor error microphone 300 is a microphone for obtaining an error in noise reduction. The monitor error microphone 300 corresponds to a first error microphone in the claims. The monitor error microphone 300 is not removed and remains installed even at the time of performing noise cancellation. The virtual error microphone, which is installed at the time of creating the observation filter and before the performance of noise cancellation and removed at the time of performing the noise cancellation, corresponds to the second error microphone in the claims.

The signal processing device 100 generates a noise reduction signal on the basis of an output signal from the reference microphone 200 and an output signal from the monitor error microphone 300.

The speaker 400 outputs a noise reduction signal generated by signal processing device 100. As a result, noise cancellation is performed.

### [1-4. Configuration of Signal Processing Device 100]

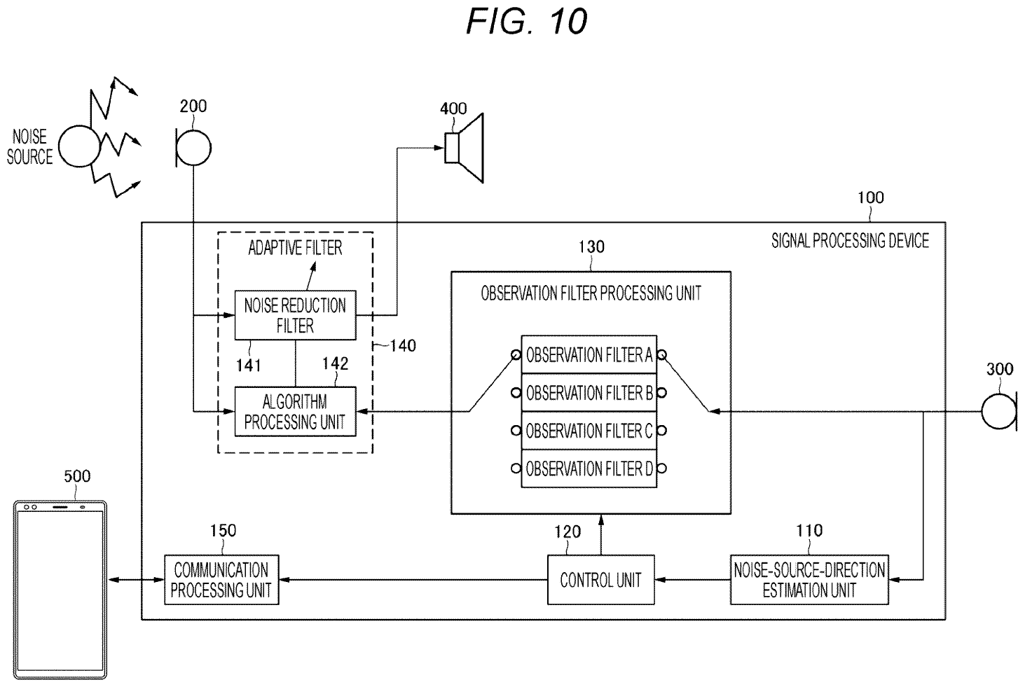

Next, the configuration of the signal processing device 100 will be described with reference to FIG. 10. The signal processing device 100 includes a noise-source-direction estimation unit 110, a control unit 120, an observation filter processing unit 130, an adaptive filter 140, and a communication processing unit 150. Note that, although one monitor error microphone 300 is illustrated in FIG. 10 for convenience of illustration, in reality, a plurality of monitor error microphones 300 is connected to the signal processing device 100, and output signals from the plurality of monitor error microphones 300 are input to the noise-source-direction estimation unit 110 and the observation filter processing unit 130.

The noise-source-direction estimation unit 110 estimates in which direction the noise source is present with respect to the target space on the basis of the output signals from the plurality of monitor error microphones 300. The noise-source-direction estimation unit 110 estimates the direction of the noise source periodically, or continuously at a predetermined timing, and supplies noise source direction information that is the estimation result to the control unit 120. Since the noise-source-direction estimation unit 110 continuously estimates the direction of the noise source at predetermined time intervals, even when the noise source moves, noise cancellation can be appropriately performed corresponding to the movement.

On the basis of the noise source direction information, the control unit 120 selects an observation filter corresponding to the direction of the noise source from among the plurality of observation filters generated in advance in association with the plurality of directions, respectively. Then, a control signal for using the selected observation filter is output to the observation filter processing unit 130. As a result, the observation filter used in the observation filter processing unit 130 is switched corresponding to the direction of the noise source.

Note that, on the basis of the noise source direction information, the observation filter processing unit 130 may perform processing to select the observation filter corresponding to the direction in which a noise source is present from among the plurality of observation filters. In this case, the noise source direction information may be directly supplied from the noise-source-direction estimation unit 110 to the observation filter processing unit 130, or may be supplied via the control unit 120.

The observation filter processing unit 130 estimates the output signal of the virtual error microphone from the output signal of the monitor error microphone 300 by using any one or more of the plurality of observation filters generated in advance, and generates an estimated output signal. Any one or more of the plurality of observation filters is the observation filter selected corresponding to the direction of the noise source in the plurality of observation filters. There is a plurality of monitor error microphones 300, and output signals from all the monitor error microphones 300 are input to the selected observation filter. The observation filter processing unit 130 supplies the estimated output signal to the adaptive filter 140. The estimated output signal is equivalent to a signal output when the virtual error microphone is actually arranged, and the filter coefficient of the adaptive filter 140 is sequentially updated by the estimated output signal and the output signal of the reference microphone 200.

The plurality of observation filters may be stored in a storage device such as a memory in association with directions with respect to a processing space, and the observation filter processing unit 130 may refer to the memory and read an observation filter to be used.

The adaptive filter 140 includes noise reduction filter 141 and algorithm processing unit 142. The estimated output signal and the output signal from the reference microphone 200 are input to the adaptive filter 140. The adaptive filter 140 generates a noise reduction signal by convolving a filter coefficient with sound collected by the reference microphone 200 so that the estimated output signal is reduced. Then, noise cancellation is performed by outputting the noise reduction signal from the speaker 400. At the time of generating the noise reduction signal, if an adaptive algorithm such as LMS is used in the algorithm processing unit 142, the filter converges so that the sound pressure at the position where the error microphone is installed automatically approaches zero.

Examples of the algorithm used by the algorithm processing unit 142 include a learning identification method, a projection method, and a Recursive Least Squares (RLS) method in addition to the LMS.

The communication processing unit 150 communicates with an external device 500 (such as a smartphone) under the control of the control unit 120. The communication method in the communication processing unit 150 may be wired or wireless, and specifically is cellular communication such as 3TTE, Wi-Fi, Bluetooth (registered trademark), near-field communication (NFC), Ethernet (registered trademark), high-definition multimedia interface (HDMI (registered trademark)), universal serial bus (USB), or the like.

The noise source direction information can be transmitted to the external device 500 through communication by the communication processing unit 150. Then, by presenting the noise source direction information to a user in the external device, the user can know in which direction the noise source is present. The external device 500 may be a device other than a smartphone, such as a tablet terminal, wearable device, personal computer, or server device.

The signal processing device 100 is configured as described above. The signal processing device 100 may be configured as a single device, or may operate in an electronic device such as a personal computer, a tablet terminal, a smartphone, or a server device. Furthermore, the signal processing device 100 may be achieved by causing a computer to perform a program. The program may be installed in the electronic device in advance, or may be distributed by downloading, a storage medium, or the like, and installed by the user.

### [1-5. Processing by Signal Processing Device 100]

Next, the processing by the signal processing device 100 will be described. First, the creation of the observation filter corresponding to each direction with respect to the processing space will be described. The signal processing device 100 according to the present technology selects an observation filter to be used from among a plurality of observation filters in accordance with the direction of the noise source. Therefore, it is necessary to create a plurality of observation filters corresponding to the respective directions in advance before noise cancellation is performed.

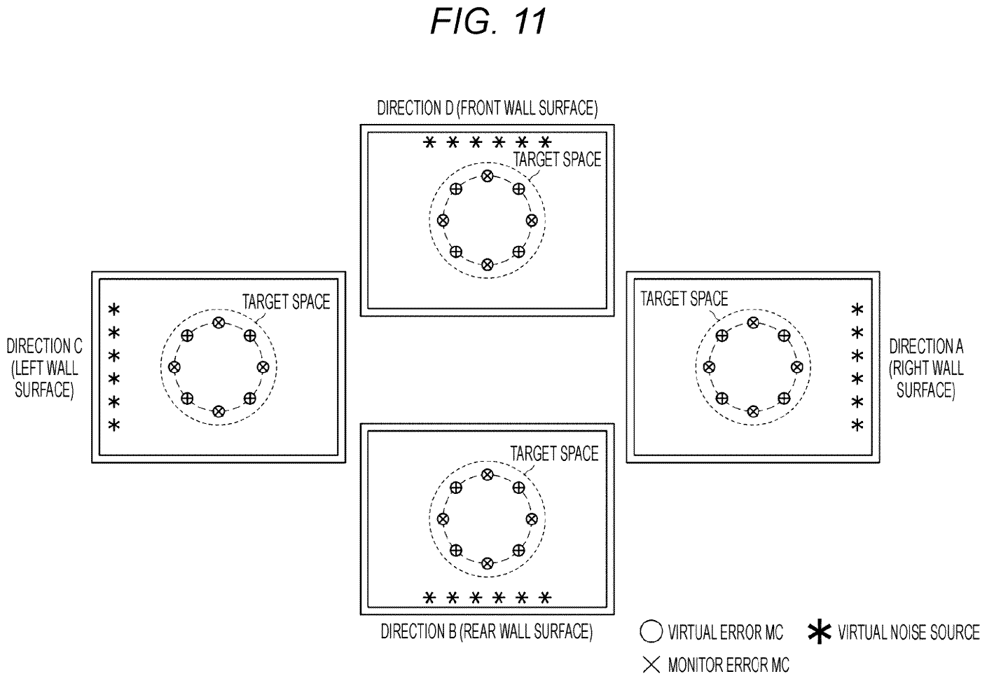

A case is assumed where the target space to be subjected to noise reduction processing is in a rectangular room formed by four wall surfaces as illustrated in FIG. 11. Before noise cancellation is performed, four observation filters (A, B, C, D) corresponding to the directions of the respective wall surfaces are created in advance by using actual measurement data, which was acquired by simulation or measurement using eight virtual error microphones and eight monitor error microphones 300 installed in advance substantially at the center of the room formed by the four wall surfaces.

Note that the number of virtual error microphones and monitor error microphones is not limited to eight, and may be any number. In addition, the number of observation filters is not limited to four, and may be any number as long as it is two or more. In the present embodiment, the number of the observation filters is four since the observation filters are created corresponding to the directions of the four wall surfaces constituting the room. Although FIG. 11 illustrates four rooms, it does not show that there are four different rooms, but shows that there is one common room and the observation filter is created corresponding to each of the directions of the four wall surfaces of this one room.

The observation filter A corresponds to direction A (right wall surface), the observation filter B corresponds to direction B (rear wall surface), the observation filter C corresponds to direction C (left wall surface), and the observation filter D corresponds to direction D (front wall surface).

A method of creating the observation filter is similar to the method described above. The first observation filter is created using a plurality of virtual noise sources arranged substantially linearly along the right wall surface in direction A. The second observation filter is created using a plurality of virtual noise sources arranged substantially linearly along the rear wall surface in direction B. The third observation filter is created using a plurality of virtual noise sources arranged substantially linearly along the left wall surface in direction C. The fourth observation filter is created using a plurality of virtual noise sources arranged substantially linearly along the front wall surface in direction D.

Each observation filter created for its corresponding direction in this manner exhibits a high noise cancellation effect for noise coming from the corresponding direction, but is weak for noise coming from other directions. Therefore, in the present technology, the direction of the noise source is estimated using the output signal from the monitor error microphone 300, and the observation filter corresponding to the direction of the noise source is selected and dynamically switched to perform noise cancellation.

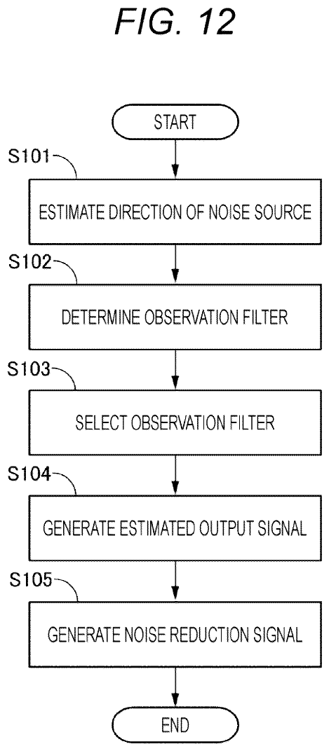

Next, the processing by the signal processing device 100 will be described with reference to a flowchart in FIG. 12. First, in step S101, the noise-source-direction estimation unit 110 estimates the direction in which the noise source is present on the basis of the output signal from the monitor error microphone 300.

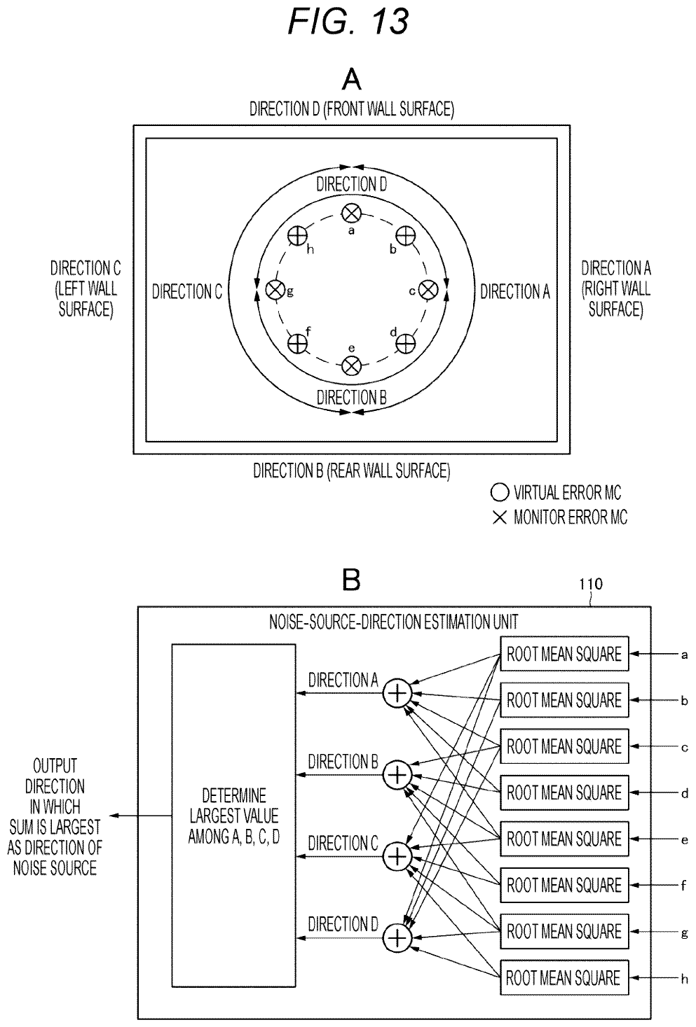

Here, a method of estimating the direction of the noise source by the noise-source-direction estimation unit 110 will be described. For example, as illustrated in FIG. 13A, it is assumed that eight monitor error microphones 300 (a to h) are annularly arranged in the target space. Then, five monitor error microphones 300 are allocated to each of the directions (direction A, direction B, direction C, direction D) of the four wall surfaces.

In FIG. 13A, the monitor error microphones 300 (a, b, c, d, e) are allocated to direction A. Further, the monitor error microphones 300 (c, d, e, f, g) are allocated to direction B. Moreover, the monitor error microphones 300 (e, f, g, h, a) are allocated to direction C. Furthermore, the monitor error microphones 300 (g, h, a, b, c) are allocated to direction D.

Then, as illustrated in FIG. 13B, the noise-source-direction estimation unit 110 takes the root mean squares of the output signals of the respective monitor error microphones 300 (a to h) over a certain period of time, and sums up the root mean squares with respect to each direction. Then, the direction in which the sum is largest is estimated as the direction of the noise source.

The description returns to the flowchart in FIG. 12. Next, in step S102, the control unit 120 determines an observation filter to be used on the basis of the estimation result of the noise-source-direction estimation unit 110, and outputs a control signal for using the observation filter to the observation filter processing unit 130.

Next, in step S103, the observation filter processing unit 130 selects an observation filter to be used on the basis of the control signal from the control unit 120.

Next, in step S104, an estimated output signal of the virtual error microphone is generated using the observation filter selected by the observation filter processing unit 130 and the output signal of the monitor error microphone 300, and is output to the adaptive filter 140.

Next, in step S105, the adaptive filter 140 generates a noise reduction signal by using the output signal and the estimated output signal of the reference microphone 200. Then, noise cancellation is performed by outputting the noise reduction signal from the speaker 400.

The processing in the first embodiment is performed as described above. According to the first embodiment, an observation filter corresponding to a direction of a noise source is selected from among a plurality of observation filter, and an estimated output signal of a virtual error microphone is generated using the selected observation filter. Then, a noise reduction signal is generated using the estimated output signal, effective noise cancellation corresponding to the direction of the noise source can be performed.

The noise-source-direction estimation unit 110 estimates the direction of the noise source periodically, or continuously at a predetermined timing, and selects the observation filter to be used on the basis of the estimation result, so that the observation filter is automatically switched when the direction of the noise source is changed. This enables noise cancellation to always be performed using the optimal observation filter. In addition, since the virtual error microphone has been removed from the target space at the time of performing noise cancellation, the virtual error microphone does not disturb people.

### 2. Second Embodiment

### [2-1. Configuration of Signal Processing Device 100]

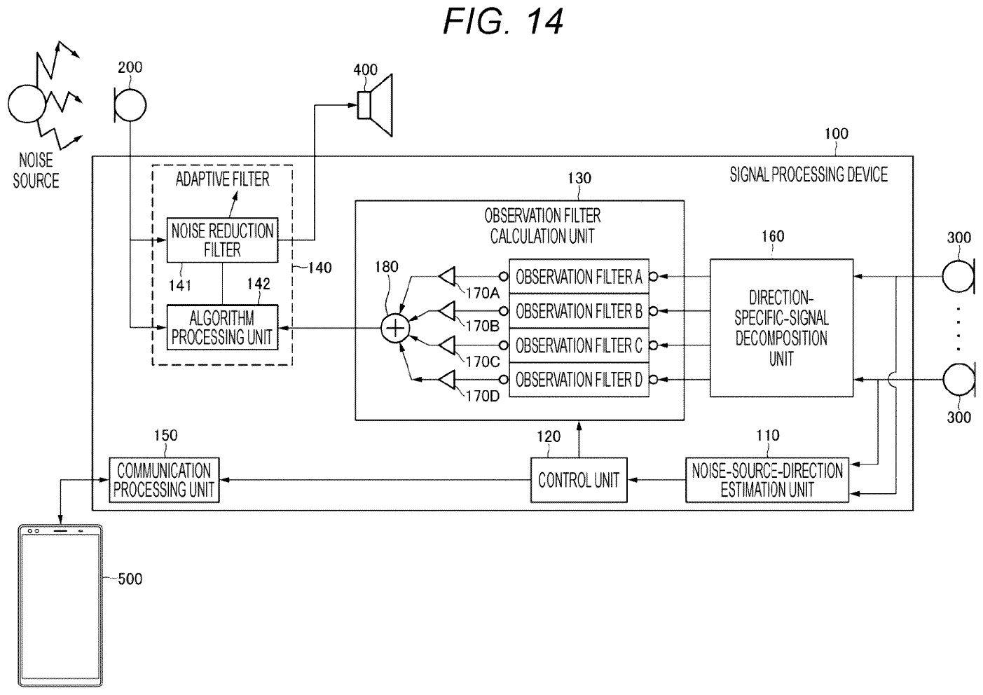

Next, a second embodiment of the present technology will be described. A configuration of a signal processing device 100 in the second embodiment will be described with reference to FIG. 14. A signal processing device 100 in the second embodiment is different from that in the first embodiment in that it includes a direction-specific-signal decomposition unit 160, a gain adjustment unit 170, and a combining unit 180. Other configurations are similar to those of the first embodiment. In addition, the configuration of the acoustic system 10 is also similar to that of the first embodiment.

In the description of the second embodiment, similarly to the first embodiment, it is assumed that the target space is a substantially central space in a rectangular room constituted by four wall surfaces as illustrated in FIG. 11. In addition, as illustrated in FIG. 11, it is assumed that, before noise cancellation is performed, four observation filters (A, B, C, D) corresponding to the directions of the respective wall surfaces are created in advance using actual measurement data, which was acquired by simulation or measurement using eight virtual error microphones and eight monitor error microphones 300 installed in advance substantially at the center of the room formed by the four wall surfaces. In FIG. 11, similarly to what has been described in the first embodiment, it is assumed that the observation filters are created corresponding to the directions of the four wall surfaces of the substantially rectangular room.

The observation filter A corresponds to direction A (right wall surface), the observation filter B corresponds to direction B (rear wall surface), the observation filter C corresponds to direction C (left wall surface), and the observation filter D corresponds to direction D (front wall surface). Note that the number of observation filters is not limited to four, and may be any number as long as it is two or more. In the present embodiment, the number of the observation filters is four since the observation filters are created corresponding to the directions of the four wall surfaces constituting the room.

The direction-specific-signal decomposition unit 160 performs processing to decompose the output signals from the plurality of monitor error microphones 300, which were input at the time of performing noise cancellation, with respect to each direction using the beamforming technology. The monitor error microphone 300 includes at least two microphones.

The direction-specific-signal decomposition unit 160 inputs the output signal from the monitor error microphone 300, which was decomposed with respect to direction A, to the observation filter A. Further, the output signal from the monitor error microphone 300 decomposed with respect to direction B is input to the observation filter B. Moreover, the output signal from the monitor error microphone 300 decomposed with respect to direction C is input to the observation filter C. Furthermore, the output signal from the monitor error microphone 300 decomposed with respect to direction D is input to the observation filter D.

Each of the observation filters outputs the generated estimated output signal to its corresponding gain adjustment unit 170. The generation of the estimated output signal in the observation filter is similar to the method described in the first embodiment.

The gain adjustment units 170A to 170D are provided corresponding to the respective observation filters A to D, each gain adjustment unit 170 adjusts the gain of the estimated output signal output from its corresponding observation filters and outputs the adjusted gain to the combining unit 180. Note that, in FIG. 14, the signal processing device 100 includes four gain adjustment units: a gain adjustment unit 170A, a gain adjustment unit 170B, a gain adjustment unit 170C, and a gain adjustment unit 170D. However, the number of gain adjustment units corresponds to the number of observation filters, and the number of gain adjustment units is not always limited to four. The same number of gain adjustment units as the observation filters are provided corresponding to the observation filters.

Each gain adjustment unit 170 adjusts the gain of the estimated output signal on the basis of the amount of gain adjustment set by the user in the external device 500. This enables the user to perform any adjustment on the magnitude of the estimated output signal in each direction corresponding to the observation filter.

Noise source direction information, which is the estimation result by the noise-source-direction estimation unit 110, may be transmitted to the external device 500 through communication by the communication processing unit 150 so that the user can set the amount of gain adjustment. By presenting the noise source direction information to the user in the external device 500, the user can check the direction of the noise source and set the amount of gain adjustment.

Then, the amount of gain adjustment (external information) set by the user and transmitted from the external device 500 is received by the communication processing unit 150 and supplied to the gain adjustment unit 170 via the control unit 120. This enables the adjustment of the gain on the basis of the setting performed by the user. Note that the user may directly set the gain adjustment information in the signal processing device 100 without the external device 500.

For example, in a case where the noise sources are present in direction A and direction C, respectively, and the user desires to reduce the noise coming from direction A, but considers that the noise coming from direction C does not need to be reduced, the gain adjustment unit 170C corresponding to the observation filter C reduces the gain of the estimated output signal. The degree of noise reduction can be adjusted by adjusting the gain of the estimated output signal in this manner.

Examples of the external device 500 include a smartphone, a tablet terminal, a wearable device, a personal computer, and a server device.

The combining unit 180 combines the gain-adjusted estimated output signals output from the respective gain adjustment units 170A to D to generate one combined estimated output signal, and outputs the combined estimated output signal to the adaptive filter 140.

The signal processing device 100 is configured as described above. The signal processing device 100 may be configured as a single device or may operate in an electronic device, and the signal processing device 100 may be achieved by causing a computer to perform a program similarly to the first embodiment.

### [2-2. Processing by Signal Processing Device 100]

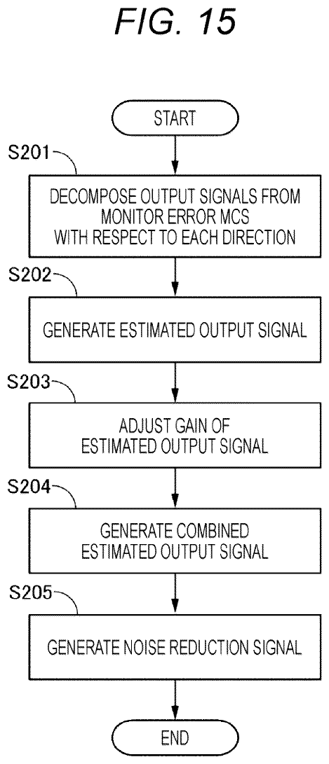

The processing by the signal processing device 100 will be described with reference to a flowchart in FIG. 15. First, in step S201, the direction-specific-signal decomposition unit 160 decomposes output signals from the plurality of monitor error microphones 300 with respect to each direction and outputs the signal to the observation filter with respect to each direction.

Next, in step S202, the observation filter processing unit 130 generates an estimated output signal of the virtual error microphone by using the observation filter and the output signal of the monitor error microphone 300 decomposed with respect to each direction, and outputs the estimated output signal to the gain adjustment unit 170.

Next, in step S203, the gain adjustment unit 170 adjusts the gain of each estimated output signal and outputs the gain to the combining unit 180.

Next, in step S204, the combining unit 180 combines the plurality of estimated output signals to generate one combined estimated output signal, and outputs the combined estimated output signal to the adaptive filter 140.

Then, in step S205, the adaptive filter 140 generates a noise reduction signal by using the output signal of the reference microphone 200 and the combined estimated output signal. Then, noise cancellation is performed by outputting the noise reduction signal from the speaker 400.

The processing in the second embodiment is performed as described above. According to the second embodiment, the output signals of the monitor error microphones 300 are decomposed with respect to each direction by using the beamforming technology, and the gain of each estimated output signal generated is adjusted, enabling the degree of noise reduction to be adjusted with respect to each direction.

Even in a case where noise sources are present in a plurality of directions, noise cancellation can be performed using a plurality of observation filters corresponding to the respective directions of the plurality of noise sources, instead of using only any one of the plurality of observation filters. For example, in a case where noise sources are present in two directions, the second embodiment is excellent in that noise cancellation can be performed using two observation filters.

Note that the virtual error microphone is not installed in the target space at the time of performing noise cancellation, and hence the virtual error microphone does not disturb people, similarly to the first embodiment.

### <3. Specific Examples of Implementation>

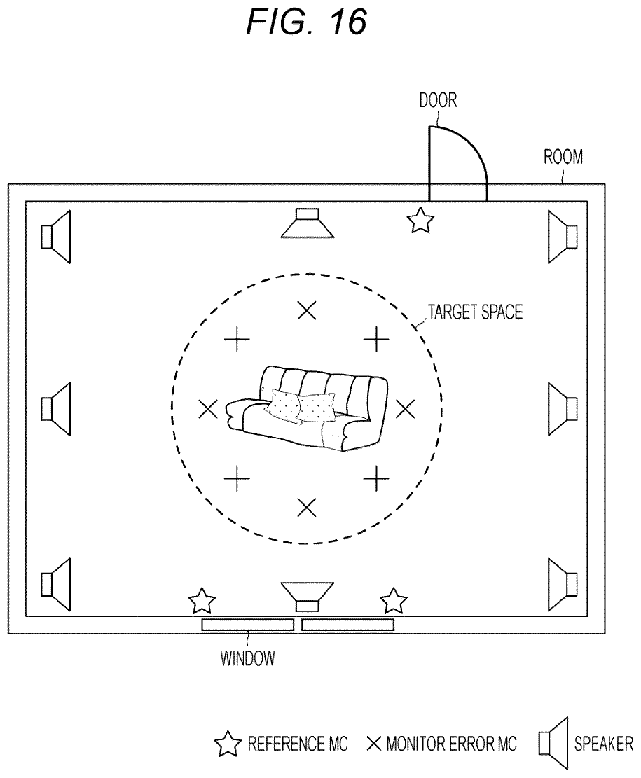

Next, a specific example of the implementation of the present technology will be described. However, the following specific examples are merely examples, and the application of the present technology is not limited to the following examples. First, a first specific example will be described with reference to FIG. 16. The first specific example is an example in which spatial noise cancellation is performed in a room of an ordinary home.

In the ordinary home, it is difficult to perform measurement in advance to create an observation filter. Therefore, a method is desirable in which a plurality of observation filters is created in advance by simulation, and an observation filter is selected at the time of performing noise cancellation.

First, a reference microphone and a monitor error microphone are installed in a room. The reference microphone is preferably installed at a position where noise is considered likely to enter, for example, around a door or around a window. The monitor error microphone is disposed at a position that does not disturb people, such as by being suspended from the ceiling above a target space, which is a noise cancellation target, or being embedded in the floor of the target space.

Then, in order to create an observation filter as a preliminary preparation for noise cancellation, for example, a smartphone is used to capture images or videos of the positions of the reference microphone, the monitor error microphone, and a speaker in the room that is the target space. Next, a target space in which noise is desired to be reduced is registered using an application or the like that runs on the smartphone. One method of registration is, for example, displaying an icon, such as a frame or a sphere, on the through image during image capture using the camera function of the smartphone, and placing the icon in the target space for registration. Another method may be outputting measured sound from the speaker, measuring the position of the smartphone, and registering that position.

Then, from the information of the registered target space, the application automatically sets the installation position of the virtual error microphone. For example, the height at which the head of a person in a standing or seated position is located in the target space is set as the installation position of the virtual error microphone. Furthermore, the positions of a plurality of virtual error microphones may be uniformly set such that intervals between the virtual error microphones are equal in the registered target space. Moreover, for example, in a case where there is a light on the ceiling of the room, the microphone can be suspended from that light, and the position immediately below the light can be set as the position of the virtual error microphone.

In addition, the shape of the room, the installation position of the reference microphone, and the position of the monitor error microphone may be calculated from the images or videos captured using the smartphone, and a plurality of observation filters may be created in consideration of the shape of the room.

The smartphone transmits the observation filter created by the application to the signal processing device 100 through communication such as Bluetooth (registered trademark) or Wi-Fi. Then, the signal processing device 100 performs noise cancellation using the observation filter.

Although a smartphone has been used in the above description, a tablet terminal, a wearable device, or the like may be used as long as similar processes such as image capture and registration can be performed.

Note that three-dimensional map information of the room may be created by simultaneous localization and mapping (SLAM), and the registration of the target space, the setting of the installation position of the virtual error microphone, and the like may be performed using the map information.

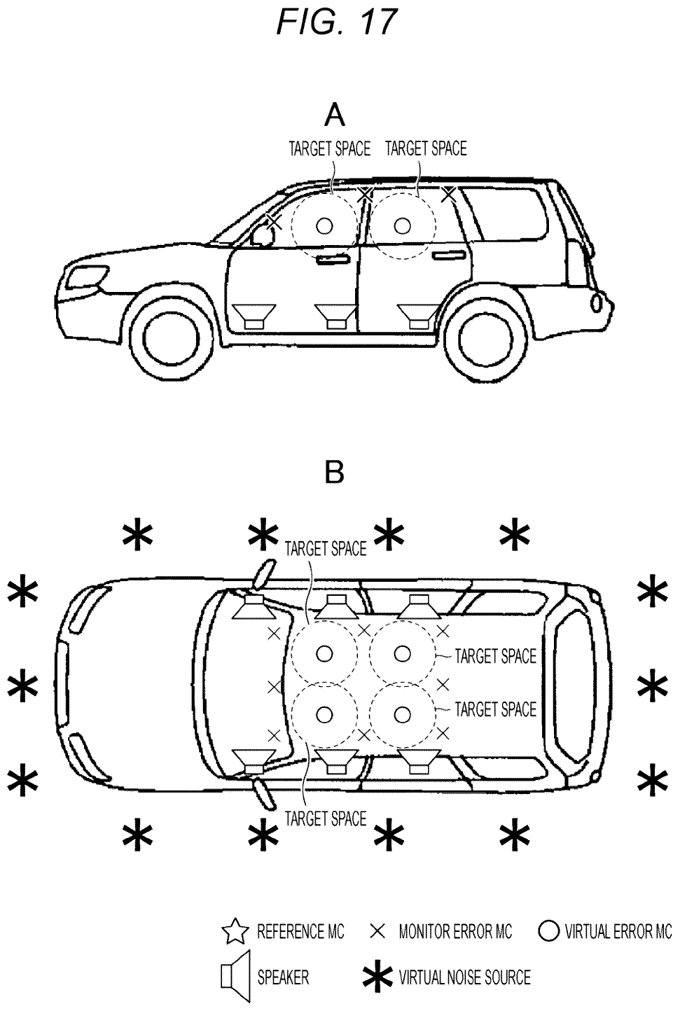

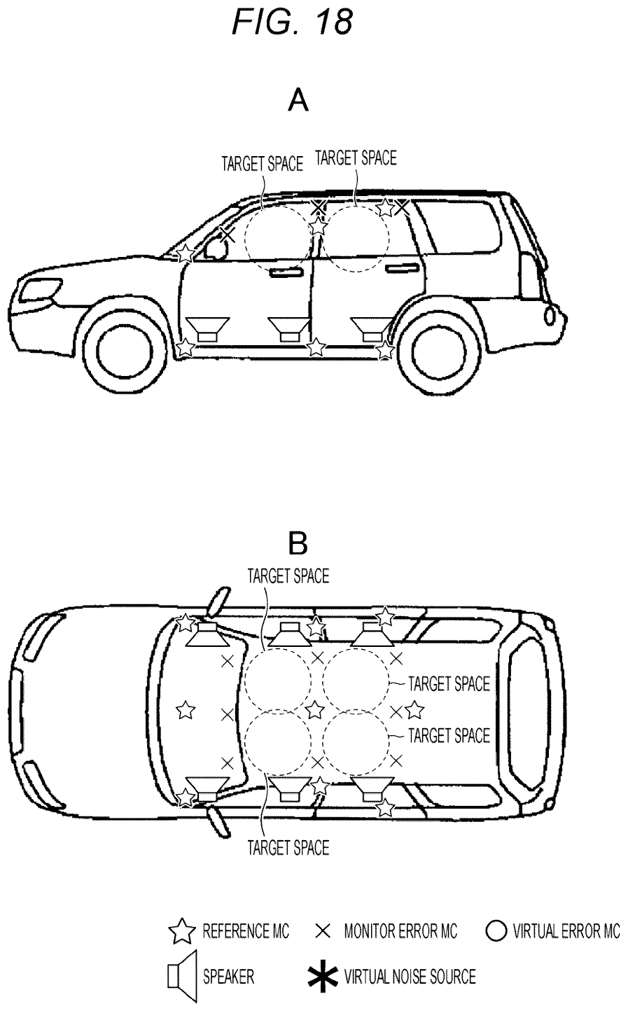

Next, a second specific example will be described with reference to FIGS. 17 and 18. The second specific example is an example in which the noise cancellation system is assumed to be used in a vehicle and is mounted on the vehicle in advance.

In the case of a vehicle, it is desirable to perform measurement at the time of completion or shipment of the vehicle and acquire actual measurement data to create an observation filter.

The reference microphone is installed at a position where noise is likely to enter, for example, near a door, and the monitor error microphone is installed on a ceiling or the like that does not disturb people. The speaker may also be used as a music playback speaker such as a car audio system.

As illustrated in FIG. 17, before noise cancellation is performed, the virtual error microphone is installed at a position corresponding to both the seat position and the head position of a person in the vehicle to perform measurement. Using a dummy head, such as head and torso simulators (HATS), is effective because this makes the measurement of the virtual error microphone more realistic.

In addition, a plurality of speakers directed in various directions is installed outside the vehicle as virtual noise sources for measurement, measured sound is output, and a transfer function from each virtual noise source to the virtual error microphone is measured. Furthermore, a transfer function from each virtual noise source to the monitor error microphone is measured. The internal structure and size of the vehicle vary depending on the vehicle type, and measurement is preferably performed for each vehicle type. Note that a plurality of speakers as virtual noise sources may be installed, or the same speaker may be moved and used as different virtual noise sources.

After the end of the measurement, an observation filter is created for each vehicle type. This is because the internal structure and width of the vehicle vary for each vehicle type. Furthermore, after the measurement, the virtual error microphone and the speaker as the virtual noise source are removed. Then, in the signal processing device 100 that operates in the vehicle, the observation filter is set to be usable. For example, the signal processing device 100 may operate in an in-vehicle device such as a car audio system, or may operate in a terminal device such as a smartphone connected to the in-vehicle device.

After the observation filter is set in the signal processing device 100, as illustrated in FIG. 18, the virtual error microphone is removed, and the reference microphone, the monitor error microphone, and the speaker are installed in the vehicle. Then, during travel, the signal processing device 100 automatically operates, and noise cancellation is turned on. In addition, if the position of the noise source changes according to travel, the signal processing device 100 automatically switches the observation filter accordingly.

Note that, also for in-vehicle use, similarly to the first specific example, the observation filter can be created through a simulation using an image or a video captured inside the vehicle.

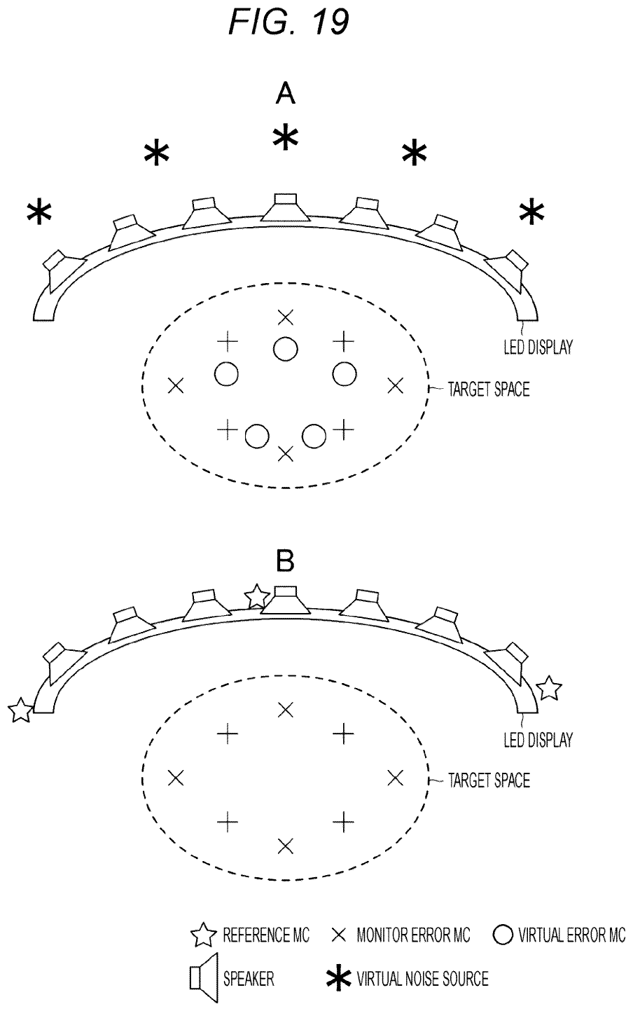

Next, a third specific example will be described with reference to FIG. 19. The third specific example is an example in which spatial noise cancellation is performed in a studio where a movie, a drama, or the like is filmed.

At present, a widely used method at filming sites is installing a huge light-emitting diode (LED) display in a studio to project the background and the like for filming.

In a case where recording is performed at such a filming site, various objects are placed around the LED display, or filming staff is moving or working, and this may cause generation of noise that affects the recording. In addition, it is not clear from which direction the noise comes. In such a case, it is optimal to set a range for filming with a camera within the filming site as the target space that is the target for noise cancellation. In addition, the use of the virtual microphone eliminates the need to install the virtual error microphone in the target space at the time of filming, and hence the virtual error microphone does not disturb filming.

The creation of the observation filter is preferably performed using actual measurement data acquired by measurement, similarly to the second specific example described above. As illustrated in FIG. 19A, the monitor error microphone is desirably installed above the target space. For example, it is desirable to extend and install an arm from the LED display or suspend the arm from the ceiling in the filming site. The virtual error microphone is installed at a position with the height of the head of a person in the target space. Alternatively, the monitor error microphone may be made movable downward, and the monitor error microphone lowered downward may be used as the virtual error microphone.

Furthermore, as illustrated in FIG. 19A, a plurality of speakers is installed as virtual noise sources at places predicted as directions from which noise will come, and measured sound is output. Then, a transfer function from each of the virtual noise sources to the virtual error microphone is measured. Furthermore, a transfer function from each virtual noise source to the monitor error microphone is measured. Note that a plurality of speakers as virtual noise sources may be installed, or the same speaker may be moved and used as different virtual noise sources.

After the end of the measurement, an observation filter is created. Furthermore, after the measurement, the virtual error microphone and the speaker as the virtual noise source are removed. Note that, in a case where the microphone used as the monitor error microphone is lowered and used as the virtual error microphone, it is only necessary to raise the microphone to a height that does not disturb a person above.

After the observation filter is set in the signal processing device 100, as illustrated in FIG. 19B, the reference microphone is installed at a position where noise is likely to enter. For example, in a case where it is considered that noise comes from above the LED display, a plurality of reference microphones is installed at intervals above the LED display.

Then, at the time of filming, the signal processing device 100 is operated to turn on noise cancellation. When filming is started in synchronization with a camera for filming or the like, the signal processing device 100 may automatically operate to turn on noise cancellation. If the position of the noise source changes during filming, the signal processing device 100 automatically switches the observation filter accordingly.

Note that, also in the case of a studio for business use, an observation filter can be created from a simulation by using an image or a video captured in the filming site, similarly to the first specific example.

### <4. Modifications>

Although the embodiments of the present technology have been specifically described above, the present technology is not limited to the embodiments described above, and various modifications based on the technical idea of the present technology are possible.

In the embodiment, it has been described that both the microphone serving as the virtual error microphone and the microphone serving as the monitor error microphone are installed. However, the monitor error microphone may be made movable downward, and the monitor error microphone lowered downward may be used as the virtual error microphone. As described above, the monitor error microphone and the virtual error microphone can also be achieved by changing the installation position of the same microphone. In this case, it is not necessary to install a microphone for a virtual error microphone.

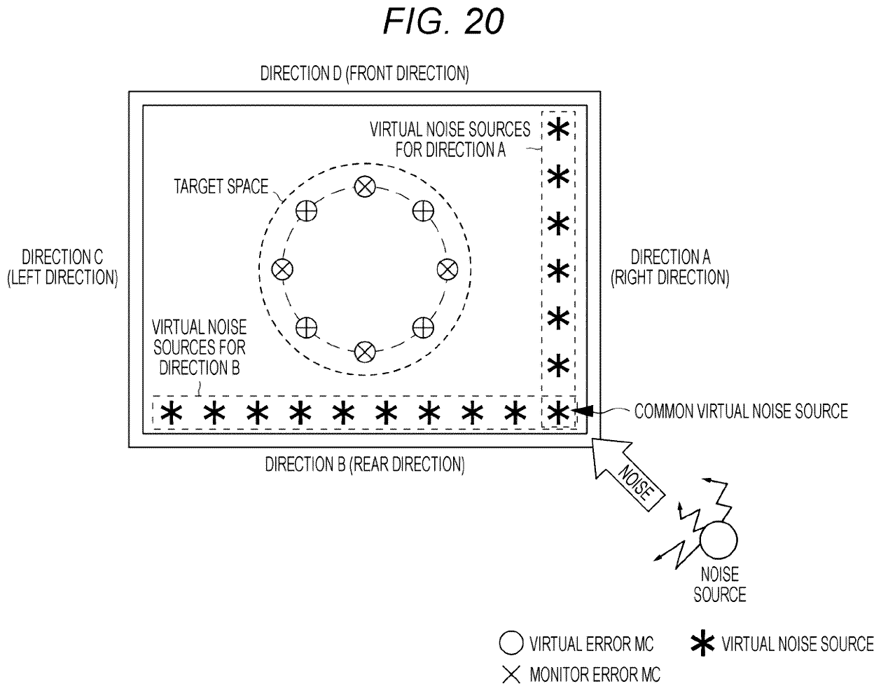

In the embodiment, it has been described with reference to FIG. 11 that the observation filter is created by arranging a plurality of virtual noise sources in each direction. FIG. 20 illustrates another example of the arrangement of the virtual noise sources. FIG. 20 assumes that spatial noise cancellation is performed in a substantially rectangular room, similarly to the embodiment.

A virtual noise source common to a plurality of virtual noise sources arranged substantially linearly along the right wall surface to create the observation filter A corresponding to direction A (right wall surface) and a plurality of virtual noise sources arranged substantially linearly along the rear wall surface to create the observation filter B corresponding to direction B (rear wall surface) is set. In FIG. 20, the virtual noise source at the rear right end is common.

When the virtual noise sources are set in this manner to create the observation filters, in a case where the noise source is present in the front right oblique direction, the estimated output signal corresponding to the noise coming from the front right oblique direction can be generated by using either the observation filter A corresponding to direction A (right wall surface) or the observation filter B corresponding to direction B (rear wall surface). Then, a noise reduction signal is generated using the estimated output signal, so that noise can be reduced more effectively.

This also applies to direction B (rear wall surface) and direction C (left wall surface), direction C (left wall surface) and direction D (front wall surface), and direction D (front wall surface) and direction A (right wall surface).

The present technology can also have the following configurations.

(1)

A signal processing device including:
an observation filter processing unit that generates, on the basis of an output signal from a first error microphone, an estimated output signal obtained using one or more of a plurality of observation filters to estimate an output signal from a second error microphone; and an adaptive filter that generates a noise reduction signal on the basis of an output signal from a reference microphone and the estimated output signal.
   (2)

The signal processing device according to (1), in which the estimated output signal is generated using an observation filter corresponding to a direction of a noise source, in the plurality of observation filters.

(3)

The signal processing device according to (2), further including a noise-source-direction estimation unit that estimates a direction in which the noise source is present on the basis of the output signal from the first error microphone.

(4)

The signal processing device according to (3), in which the observation filter processing unit selects the observation filter on the basis of the direction of the noise source estimated by the noise-source-direction estimation unit.

(5)

The signal processing device according to (4), further including a control unit,
in which the selection of the observation filter is performed under control of the control unit on the basis of the direction of the noise source estimated by the noise-source-direction estimation unit.
   (6)

The signal processing device according to any one of (1) to (5), in which the plurality of observation filters is stored in a memory in association with directions.

(7)

The signal processing device according to any one of (1) to (6), in which
the first error microphone includes at least two microphones, and
the signal processing device further includes a direction-specific-signal decomposition unit that decomposes output signals from the first error microphone with respect to each of directions, and outputs the output signals decomposed to the plurality of observation filters with respect to the respective directions.
   (8)

The signal processing device according to (7), further including a gain adjustment unit that adjusts a gain of the estimated output signal output from each of the observation filters.

(9)

The signal processing device according to (8), further including a combining unit that combines the estimated output signal having the gain adjusted by each of the gain adjustment units.

(10)

The signal processing device according to (8) or (9), in which the gain adjustment unit adjusts a gain in accordance with external information received through communication with an external device.

(11)

The signal processing device according to (5), further including a communication processing unit, in which information indicating the direction of the noise source estimated by the sound source direction estimation unit is transmitted to an external device on the basis of control of the control unit.

(12)

The signal processing device according to (11), in which the external device is a smartphone, a tablet terminal, a wearable device, a personal computer, or a server device.

(13)

The signal processing device according to (11), in which a communication method by the communication processing unit is Bluetooth (registered trademark) or Wi-Fi.

(14)

The signal processing device according to any one of (1) to (13), in which the observation filter is created in advance by processing with artificial intelligence.

(15)

The signal processing device according to (14), in which the artificial intelligence is trained to estimate an output signal of the second error microphone from an output signal of the first error microphone during learning.

(16)

The signal processing device according to any one of (1) to (15), in which the second error microphone is installed before performance of noise cancellation through an output of the noise reduction signal from a speaker, and is removed at the time of performing noise cancellation.

(17)

The signal processing device according to any one of (1) to (16), in which the first error microphone and the second error microphone are achieved by changing an installation position of the same microphone.

(18)

A signal processing method including:
generating, on the basis of an output signal from a first error microphone, an estimated output signal obtained using one or more of a plurality of observation filters to estimate an output signal from a second error microphone; and
generating a noise reduction signal on the basis of an output signal from a reference microphone and the estimated output signal.
   (19)

A program for causing a computer to perform a signal processing method including
generating, on the basis of an output signal from a first error microphone, an estimated output signal obtained using one or more of a plurality of observation filters to estimate an output signal from a second error microphone, and
generating a noise reduction signal on the basis of an output signal from a reference microphone and the estimated output signal.
   (20)

An acoustic system including:
a first error microphone;
a reference microphone;
an observation filter processing unit that generates, on the basis of an output signal from the first error microphone, an estimated output signal obtained using one or more of a plurality of observation filters to estimate an output signal from a second error microphone;
an adaptive filter that generates a noise reduction signal on the basis of an output signal from the reference microphone and the estimated output signal; and a speaker that outputs the noise reduction signal.

### REFERENCE SIGNS LIST

10 Acoustic system
100 Signal processing device
110 Noise-source-direction estimation unit
120 Control unit
130 Observation filter processing unit
140 Adaptive filter
150 Communication processing unit
160 Direction-specific-signal decomposition unit
170 Gain adjustment unit
180 Combining unit
200 Reference microphone
300 Monitor error microphone
400 Speaker
500 External device

1. A signal processing device comprising:
an observation filter processing unit that generates, on a basis of an output signal from a first error microphone, an estimated output signal obtained using one or more of a plurality of observation filters to estimate an output signal from a second error microphone; and
an adaptive filter that generates a noise reduction signal on a basis of an output signal from a reference microphone and the estimated output signal.

2. The signal processing device according to claim 1, wherein the estimated output signal is generated using an observation filter corresponding to a direction of a noise source, in the plurality of observation filters.

3. The signal processing device according to claim 2, further comprising a noise-source-direction estimation unit that estimates a direction in which the noise source is present on a basis of the output signal from the first error microphone.

4. The signal processing device according to claim 3, wherein
the observation filter processing unit selects the observation filter on a basis of the direction of the noise source estimated by the noise-source-direction estimation unit.

5. The signal processing device according to claim 4, further comprising a control unit,
wherein the selection of the observation filter is performed under control of the control unit on a basis of the direction of the noise source estimated by the noise-source-direction estimation unit.

6. The signal processing device according to claim 1, wherein
the plurality of observation filters is stored in a memory in association with directions.

7. The signal processing device according to claim 1, wherein
the first error microphone includes at least two microphones, and
the signal processing device further comprises a direction-specific-signal decomposition unit that decomposes output signals from the first error microphone with respect to each of directions, and outputs the output signals decomposed to the plurality of observation filters with respect to the respective directions.

8. The signal processing device according to claim 7, further comprising
a gain adjustment unit that adjusts a gain of the estimated output signal output from each of the observation filters.

9. The signal processing device according to claim 8, further comprising
a combining unit that combines the estimated output signal having the gain adjusted by each of the gain adjustment units.

10. The signal processing device according to claim 8, wherein
the gain adjustment unit adjusts a gain in accordance with external information received through communication with an external device.

11. The signal processing device according to claim 5, further comprising a communication processing unit,
wherein information indicating the direction of the noise source estimated by the sound source direction estimation unit is transmitted to an external device on a basis of control of the control unit.

12. The signal processing device according to claim 11, wherein
the external device is a smartphone, a tablet terminal, a wearable device, a personal computer, or a server device.

13. The signal processing device according to claim 11, wherein
a communication method by the communication processing unit is Bluetooth (registered trademark) or Wi-Fi.

14. The signal processing device according to claim 1, wherein
the observation filter is created in advance by processing with artificial intelligence.

15. The signal processing device according to claim 14, wherein
the artificial intelligence is trained to estimate an output signal of the second error microphone from an output signal of the first error microphone during learning.

16. The signal processing device according to claim 1, wherein
the second error microphone is installed before performance of noise cancellation through an output of the noise reduction signal from a speaker, and is removed at a time of performing noise cancellation.

17. The signal processing device according to claim 1, wherein
the first error microphone and the second error microphone are achieved by changing an installation position of a same microphone.

18. A signal processing method comprising:
generating, on a basis of an output signal from a first error microphone, an estimated output signal obtained using one or more of a plurality of observation filters to estimate an output signal from a second error microphone; and
generating a noise reduction signal on a basis of an output signal from a reference microphone and the estimated output signal.

19. A program for causing a computer to perform a signal processing method including
generating, on a basis of an output signal from a first error microphone, an estimated output signal obtained using one or more of a plurality of observation filters to estimate an output signal from a second error microphone, and
generating a noise reduction signal on a basis of an output signal from a reference microphone and the estimated output signal.

20. An acoustic system comprising:
a first error microphone;
a reference microphone;
an observation filter processing unit that generates, on a basis of an output signal from the first error microphone, an estimated output signal obtained using one or more of a plurality of observation filters to estimate an output signal from a second error microphone;
an adaptive filter that generates a noise reduction signal on a basis of an output signal from the reference microphone and the estimated output signal; and
a speaker that outputs the noise reduction signal.
